(19) United States
(12) Patent Application Publication
(10) Pub. No.: US 2026/0043423 A1
(43) Pub. Date: Feb. 12, 2026

(54) VALVE SYSTEM AND METHOD FOR OPERATING A PNEUMATIC ACTUATOR

(71) Applicant: Festo SE & Co. KG, Esslingen (DE)

(72) Inventors: Daniel KLASSEN, Esslingen (DE); Gabriel DÄMMER, Esslingen (DE); Martin KLOSOK, Waiblingen (DE)

(21) Appl. No.: 19/290,850

(22) Filed: Aug. 5, 2025

(30) Foreign Application Priority Data
Aug. 6, 2024 (DE) 10 2024 122 350.2

(51) Int. Cl. F15B 13/04; G05D 16/20

(52) U.S. Cl. CPC F15B 13/0401; G05D 16/2024; G05D 16/204; F15B 2211/526

(57) ABSTRACT

A valve system for supplying a pneumatic actuator, with a first valve group which is connected to a supply connection, to an exhaust connection and to a first working connection; with a second valve group which is connected to the supply connection, to the exhaust connection and to a second working connection; with a first pressure sensor connected with the first working connection; with a second pressure sensor connected with the second working connection; with a controller for processing a first pressure signal from the first pressure sensor and a second pressure signal from the second pressure sensor, the controller comprising a first pressure regulator for controlling the first valve group and a second pressure regulator for controlling the second valve group, the controller setting a first maximum pressure level for the first pressure regulator and setting a second maximum pressure level for the second pressure regulator.

### CROSS-REFERENCE TO RELATED APPLICATION

This application claims priority to German application no. 10 2024 122 350.2 filed Aug. 6, 2024, which is incorporation by reference.

### BACKGROUND OF THE INVENTION

The invention relates to a valve system and a method for operating a pneumatic actuator.

EP 2 644 904 B1 discloses a method for controlling a fluidically operable working system, which has an actuator with an actuator housing and an actuator member movably received in the actuator housing, which define a first and at least a second working chamber, which are designed to provide actuator forces acting in opposite directions on the actuator member, and which has a valve device designed to separately control the two working chambers, as well as a controller, wherein it is provided that the controller specifies the following steps: supplying a first predeterminable volume of a pressurized fluid to the first working chamber in order to accelerate the actuator member from a starting position to a predeterminable target speed, closing the first working chamber, allowing a second predeterminable volume of fluid contained in the second working chamber to flow out of the second working chamber, so that the actuator member is guaranteed to decelerate to a predeterminable target position.

### SUMMARY OF THE INVENTION

The object of the invention is to provide a valve system and a method for operating a pneumatic actuator, with which adaptation to different movement tasks to be performed by an actuator can be ensured.

According to a first aspect of the invention, this task is solved for a valve system for supplying a pneumatic actuator with the following features: the valve system comprises a supply connection, an exhaust connection, a first working connection to which a first pressure sensor is assigned, and a second working connection to which a second pressure sensor is assigned, as well as a first valve group connected to the supply connection and to the exhaust connection and to the first working connection, which in a first operating state exclusively opens an exhaust path between the first working connection and the exhaust connection and which in a second operating state exclusively opens a supply path between the supply connection and the first working connection, and a second valve group, which is connected to the supply connection and to the exhaust connection and to the second working connection and which, in a first operating state, exclusively opens an exhaust path between the first working connection and the exhaust connection and, in a second operating state, exclusively opens a supply path between the supply connection and the second working connection, as well as a controller, which is designed to evaluate a first pressure signal from the first pressure sensor and has a first pressure regulator for controlling the first valve group, and which is designed to evaluate a second pressure signal from the second pressure sensor and has a second pressure regulator for controlling the second valve group, and which is designed to set a first maximum pressure level for the first pressure regulator and a second maximum pressure level for the second pressure regulator.

According to a preferred embodiment of the invention, the controller is a computing device comprising: one or more processors; a non-transitory computer-readable medium; and program instructions stored on the non-transitory computer-readable medium that, when executed by the one or more processors, cause the one or more processors to perform functions comprising: processing a first pressure signal from the first pressure sensor and controlling the first valve group by means of a first pressure regulator, taking into account a first maximum pressure level for the first pressure regulator; processing a second pressure signal from the second pressure sensor and controlling the second valve group by means of a second pressure regulator, taking into account a second maximum pressure level for the second pressure regulator.

The valve system can be composed of several independent components, each of which has its own housing and can be operated independently. Each of the connections as mentioned in this application also can be named a port, in particular supply port, exhaust port, working port, input port, outlet port, . . . . The expression “exclusively opens” means that all other fluidic connections of the respective valve group are closed. It may be provided that the first pressure sensor, the first valve group, the second pressure sensor, the second valve group, and the controller are connected to each other in a fluidic and electrical manner by fluid hoses and electrical wiring, and that each of the components can be replaced individually. Alternatively, the first pressure sensor, the first valve group, the second pressure sensor, the second valve group, and the controller are housed in a common housing, in which fluid channels and electrical lines can also be integrated, thereby achieving a compact design for the valve system.

The fluid connections of the valve system, in particular the supply connection, the first working connection, and the second working connection, can be designed as hose couplings to which, for example, flexible fluid hoses can be connected. When the valve system is used as intended, fluidically communicating connections are provided between the supply connection and a fluid source, in particular a compressed air source, between the first working connection and a first fluid connection of an actuator, and between the second working connection and a second fluid connection of the actuator. Furthermore, an electrical supply is provided for the controller, which in turn is designed to electrically control the first valve group and the second valve group. The exhaust connection can also be designed as a hose coupling in order to forward the exhaust air provided by the actuator to a central exhaust air duct, for example. Alternatively, the exhaust connection may be an outlet opening from which the exhaust air can flow into the environment of the valve system. It is preferred that the exhaust connection is assigned a silencer with which the exhaust air can be silenced before it flows into the environment of the valve system.

The actuator may be a pneumatic cylinder designed to provide linear movement along a straight path and comprising a working piston mounted so as to move linearly in an actuator bore of an actuator housing, also referred to as a cylinder. The pneumatic cylinder may optionally be designed with or without a piston rod.

Alternatively, the actuator may be a pneumatic rotary actuator for providing a rotary movement about a rotary axis, in which a working piston referred to as a rotary blade is rotatably received along a circular section-shaped path of movement in an actuator bore of an actuator housing.

Regardless of the design of the actuator, the working piston always divides the actuator bore into a first variable-size working chamber and a second variable-size working chamber. The first working chamber has a first fluid connection through which the first working chamber can be ventilated and de-aerated. Furthermore, the second working chamber has a second fluid connection through which the second working chamber can be ventilated and de-aerated.

The first valve group is fluidically connected to the supply connection, the first working connection, and the exhaust connection. The first valve group is designed such that, in a first operating state, it can establish a fluidically communicating connection, referred to as an exhaust path, between the first working connection and the exhaust connection for de-aeration (pressure reduction) of the first working chamber of the actuator. Furthermore, the first valve group is designed such that, in a second operating state, it can establish a fluidically communicating connection between the supply connection and the first working connection, referred to as a supply path, for aeration (pressure increase) of the first working chamber.

Furthermore, the first valve group is electrically connected to the controller in order to receive electrical control signals from the controller and to convert these control signals into movements of at least one valve member of the first valve group. For example, it may be provided that a switchover of the first valve group between the first operating state and the second operating state is achieved with a single valve member. For this purpose, the first valve group can, for example, be designed as a 3/2-way valve or as a 3/3-way valve. Alternatively, the switching of the first fluid valve group between the first operating state and the second operating state can also be achieved with several, in particular with two, 2/2-way valves. In particular, it is provided that the first and second valve groups are identical in design.

It is preferred that the second valve group has the same structure as the first valve group and only has a connection to the second working connection instead of a connection to the first working connection.

The first pressure sensor can be arranged either directly at the first working connection or in a fluid line, in particular in a fluid hose, between the first valve group and the first working connection. The first pressure sensor can be designed as an absolute pressure sensor or as a relative pressure sensor and is electrically connected to the controller in order to provide a first pressure signal to the controller. The second pressure sensor is preferably designed in the same way as the first pressure sensor and is assigned to the second working connection. If necessary, at least one of the pressure sensors may be arranged downstream of the respective working connection, in particular at the respective fluid connection of the actuator.

The controller is designed to evaluate the first pressure signal and the second pressure signal in order to determine a first fluid pressure in the first working chamber and a second fluid pressure in the second working chamber. The controller can use the first fluid pressure to perform a first pressure control (closed loop control) for the first working chamber. For this purpose, the controller has a first pressure regulator, which can be either an electrical or electronic circuit as part of the controller or a computer program, wherein the computer program is executed in a microprocessor, which is a component of the controller. In the same way, the controller can perform a second pressure control (closed loop control) for the second working chamber with the second fluid pressure.

For the first pressure control, the controller takes into account a first maximum pressure level, and for the second pressure control, the controller takes into account a second maximum pressure level. The first maximum pressure level and the second maximum pressure level can be identical or different.

It is preferred that the controller has an internal memory for storing the first and second maximum pressure levels. It is particularly preferred that different first and second maximum pressure levels, in particular pairs of values of first and second maximum pressure levels, are stored in the internal memory. The stored maximum pressure levels are preferably used when the actuator is always to perform the same movement task. In this case, it may be provided that the maximum pressure levels for performing the movement task are determined experimentally, whereby the experimental determination is designed to achieve the movement of the actuator taking into account all boundary conditions such as positioning speed of the actuator, positioning accuracy of the actuator, actuator stiffness, with minimum energy consumption. For example, it may be provided that a supply pressure for the actuator is reduced in small steps during the determination of the maximum pressure levels until the movement task is just barely fulfilled with its boundary conditions. The working pressures required individually for the two working chambers are then stored as the first maximum pressure level and the second maximum pressure level.

Alternatively, the controller determines the first maximum pressure level and the second maximum pressure level from a motion task that is either stored in the controller or provided to the controller by a higher-level control system in particular a programmable logic control (PLC). The movement task may, for example, be designed to move the working piston of the actuator at a specified travel speed and/or while maintaining a specified stiffness and/or with a specified positioning accuracy. The movement task may also be designed to vary the travel speed and/or the stiffness and/or the positioning accuracy during the movement of the working piston.

In order to be able to determine the first maximum pressure level and the second maximum pressure level from the movement task, the controller may be designed to perform a mean pressure optimization. This mean pressure optimization aims to determine the mean pressure required to fulfill the movement task, for example by using a calculation model stored in the controller, and to calculate the first maximum pressure level and the second maximum pressure level by means of the calculation model. The mean pressure optimization aims to find the minimum mean pressure at which the motion task can still be performed. For this purpose, the controller takes into account not only the boundary conditions contained in the motion task, but also the dimensions of the actuator and/or the properties of a component to be moved by the actuator. The component to be moved may be, for example, a machine part that is to be moved by the actuator between a first functional position and a second functional position. When the motion task is subsequently performed, the compressed air is supplied to the first and second working chambers of the actuator while maintaining the first maximum pressure level and the second maximum pressure level.

One way of optimizing the mean pressure is to model the actuator as a system with a mass held on both sides by springs. It is crucial here that the same spring stiffness is assumed for the two springs in a center position of the mass, in which the two working chambers of the actuator have the same volume. If, on the other hand, the mass is off-center, the working chamber with the smaller volume has a higher spring stiffness than the working chamber with the larger volume. This model can be used, for example, to predict the behavior of a pneumatic cylinder that is designed to cause a displacement of a constant mass by means of a horizontal movement of the piston rod. For other applications of actuators, additional boundary conditions such as non-linear kinematics may need to be taken into account for modeling. In principle, it is possible to provide for a change in the mean pressure during the execution of the motion task so that only the minimum amount of energy required to perform the motion task is used in each phase of the motion to be performed by the actuator. The objective for determining the first maximum pressure level and the second maximum pressure level is therefore to always select these two values in dependence on the boundary conditions of the movement task in such a way that the energy input required to perform the movement task is minimal.

Compared to an operating mode for the actuator that is carried out without mean pressure optimization, an operating mode for the actuator that is carried out with mean pressure optimization results in reduced energy consumption and reduced wear, since the components of the actuator are subjected to less stress due to the lower pressure level.

The first maximum pressure level and the second maximum pressure level are taken into account in the first pressure regulator and in the second pressure regulator during pressure control in such a way that the pressure at the first working connection and at the second working connection is always held below the respective maximum pressure level. A brief exceeding of the first maximum pressure level and/or the second maximum pressure level can be tolerated provided that this exceeding occurs within a specified pressure interval and/or time interval. Such exceeding does not compromise the function of the valve system or the function of the actuator. Rather, the relationship between the movement task and the two maximum pressure values is based on the consideration that some movement tasks can be performed with lower maximum pressure values, since only low demands are placed on the travel speed and/or the stiffness and/or the positioning accuracy and the low maximum pressure values allow high energy efficiency to be achieved for this movement task. In contrast, for another motion task, it may be necessary for at least one parameter from the group consisting of actuator travel speed, actuator stiffness, and actuator positioning accuracy to meet a high requirement, and therefore high first and second maximum pressure values must also be specified, which are associated with reduced energy efficiency.

Advantageous further developments of the invention are the subject of the subclaims.

It is advantageous if the controller has a sensor interface for an electrical connection with a position sensor, which position sensor may be assigned to an actuator and if the controller is designed to process a position signal from the position sensor, and if the controller comprises a position controller with which the position signal can be used for actuator position control (closed loop). The sensor interface can be designed as an electromechanical plug connector which is connected to the controller via a cable connection and which enables the coupling of an analog or digital position signal from a discrete position sensor. Alternatively, the sensor interface can be designed as a communication interface via which a digital communication signal, for example a bus signal of an industrial bus system or an IO-Link signal, can be coupled in, which digital communication signal is provided by the position sensor or by a communication system looped in between the position sensor and the controller. The position sensor provides a position signal that depends on a position of the working piston along the movement path and that is used in the controller to perform position control for the actuator. The position controller required for this purpose can be designed as an electrical or electronic circuit of the controller or as a computer program that is executed in a microprocessor of the controller. It is preferred that the position controller, the first pressure controller, and the second pressure controller form a cascade control system. In this case, it may be provided that the position controller is used as a master controller to which the two pressure controllers are subordinate. In particular the controller is a computing device as mentioned above and the program instructions cause the one or more processors to perform functions comprising: using the position signal of the position sensor for an actuator position control (closed loop) by means of a position controller.

Alternatively, it is provided that the controller is designed to evaluate the first pressure signal from the first pressure sensor and the second pressure signal from the second pressure sensor in order to determine position information for an actuator, and that the controller has a position controller with which the position information can be used for actuator position control. Such pressure-based position determination has the advantage that no additional position sensor is required. Such position determination can be carried out using a computer program running in the controller. This computer program forms an observer which determines the position information from the changes in the first and second pressure signals and without the use of a position sensor. For example, it may be provided that when a drive system comprising the valve system according to the invention and an actuator connected thereto is put into operation, calibration must first be carried out in order to be able to calculate unique position information for the working piston from the first and second pressure signals. This calibration can be performed, for example, by de-aerating one of the working chambers of the actuator and ventilating the other working chamber so that the working piston is positioned at the beginning of its movement path and the position of the working piston can be determined from this starting position on the basis of the subsequent pressure changes for the actuator. The position controller can be designed as an electrical or electronic circuit of the controller or as a computer program. It is preferred that the position controller, the first pressure controller, and the second pressure controller form a cascade control system. In this case, it can be provided that the position controller is used as a master controller, to which the two pressure controllers are subordinate. In particular the controller is a computing device as mentioned above and the program instructions cause the one or more processors to perform functions comprising: processing the first pressure signal from the first pressure sensor and processing the second pressure signal from the second pressure sensor for a determination of a position information for an actuator and controlling a position of the actuator by means of a position controller using the position information.

In a further development of the invention, it is provided that the controller has a communication interface which is designed to receive a movement task from a higher-level machine control, for example a programmable logic control (PLC), wherein the controller is designed to process the movement task in order to determine from the movement task at least one parameter from the group: first maximum pressure level, second maximum pressure level, actuator position deviation, actuator target speed, actuator target stiffness, actuator minimum speed, actuator maximum speed, and to determine the first maximum pressure level and the second maximum pressure level on the basis of the at least one parameter. The motion task defines the position change for the working piston of the actuator starting from the current position of the working piston. For example, a motion task may be designed so that the working piston is moved from its current position to a new position in a short period of time, which may be less than 1 second, with high positioning accuracy and high stiffness. Another motion task may be designed to move the working piston to a new position over a longer period of time, which may be several seconds, with low positioning accuracy and low rigidity. At least one parameter can thus be taken from the respective motion task, which parameter is used to determine the first maximum pressure level and the second maximum pressure level. For example, it is envisaged that the first maximum pressure level and/or the second maximum pressure level are contained directly, for example as a specific numerical value, in the movement task and can be used directly by the controller to perform the first and/or second pressure control. On the other hand, parameters contained in the movement task, such as the actuator position deviation, the actuator target speed, the actuator target stiffness, the actuator minimum speed, or the actuator maximum speed, require calculations to be performed in the control unit. These calculations must be specifically tailored to the properties of the actuator and/or the properties of the first valve group and the second valve group. For example, it is advantageous if the type and dimensions of the actuator are known. It is also advantageous if a fluid resistance of the first and/or second valve group, referred to as a (fluidic) conductance and dependent on the respective valve position, is known. In particular the controller is a computing device as mentioned above and the program instructions cause the one or more processors to perform functions comprising: processing the movement task for a determination of at least one parameter from the group: first maximum pressure level, second maximum pressure level, actuator position deviation, actuator target speed, actuator target stiffness, actuator minimum speed, actuator maximum speed, and a determination of the first maximum pressure level and the second maximum pressure level on the basis of the at least one parameter.

The actuator position deviation refers to a difference between a specified target position of the working piston and an actual position of the working piston during the execution of the movement task or at the end of the executed movement task.

Typically, it can be assumed that the working piston exhibits a greater actuator position deviation due to the adhesive and sliding friction effects present in the actuator if a low value is selected for the first and/or second maximum pressure level. The actuator target speed, the actuator target stiffness, and the actuator maximum speed increase with increasing amount for the first and/or second maximum pressure level. Compliance with an actuator minimum speed requires a certain amount for the first and/or second maximum pressure level.

In a further embodiment of the invention, the first valve group and the second valve group are each designed as piezo valves, in particular piezo bending valves, or solenoid valves or fluidically pilot-controlled valves.

In piezo valves, the piezoelectric effect is used to move a valve member, which is designed, for example, to seal a valve seat, relative to the valve seat. For this purpose, the piezo valve may comprise a stack of piezoelectric elements which, when an electrical voltage is applied, undergo a change in length and thus provide the desired relative movement. It is preferred that the piezoelectric element is designed in a strip shape and clamped at a first end region in a valve housing and that a sealing element serving as a valve member is attached to a second end region of the piezoelectric element. In this case, applying an electrical voltage causes a change in curvature of the piezoelectric element, so that the sealing element either rests sealingly on the valve seat or is arranged away from the valve seat and allows a fluid flow through the valve seat.

In solenoid valves, a magnetic flux is provided by applying current to an electrical coil arrangement, which can be used to cause a change in position of an armature associated with the coil arrangement. This armature can be designed directly as a valve member or for indirect actuation of a valve member.

In a fluidically pilot-controlled valve, a valve member is moved between a first functional position and a second functional position by pressurizing it with compressed air, whereby the valve member blocks a fluid flow through the valve in the first functional position and opens it in the second functional position.

It is preferred that the first valve group and the second valve group are each designed as a 3/2-way valve or as a 3/3-way valve, or that the first valve group and the second valve group each comprise two 2/2-way valves and are arranged in a full bridge circuit. The valves of the first and second valve groups are preferably designed as proportional valves, as this allows advantageous pressure control for the first and second working connections. Alternatively, the valves of the first and second valve groups are designed as switching valves which are controlled, for example, by pulse width modulated switching signals. The first and/or second valve groups can be designed as 3/2-way valves, so that the respective working connection can be either aerated or de-aerated. Alternatively, the first and/or second valve groups can be designed as 3/3-way valves, whereby, in addition to de-aerating and de-aerating the respective working connection, it is also possible to shut off the respective working connection. If the first and/or second valve group is designed as an arrangement of two 2/2-way valves, a first 2/2-way valve is arranged between the supply connection and the respective working connection, while a second 2/2-way valve is arranged between the respective working connection and the exhaust connection. The two 2/2-way valves form a half-bridge circuit. If both the first valve arrangement and the second valve arrangement are each formed by two 2/2-way valves, the connection of the two half-bridge circuits creates a full-bridge circuit. The use of 2/2-way valves in a full bridge circuit is particularly suitable for piezo bending valves.

In a further embodiment of the invention, the controller is designed such that the first maximum pressure level and the second maximum pressure level result from a mean pressure optimization which is performed by the controller on the basis of at least one boundary condition from the group: actuator position deviation, actuator target speed, actuator target stiffness, actuator minimum speed, actuator maximum speed. The first maximum pressure level and the second maximum pressure level are determined in such a way that a minimum mean pressure is used for the respective movement of the pneumatic actuator. This mean pressure must be selected such that the desired movement of the actuator can be performed reliably and the amount of energy used to generate the desired movement, which is supplied in the form of compressed air to the first working chamber and the second working chamber of the actuator, is minimal. For example, the mean pressure is a mean value formed from the first maximum pressure level and the second maximum pressure level. In particular the controller is a computing device as mentioned above and the program instructions cause the one or more processors to perform functions comprising: performing a mean pressure optimization by taking into account at least one boundary condition from the group: actuator position deviation, actuator target speed, actuator target stiffness, actuator minimum speed, actuator maximum speed to determine the first maximum pressure level and the second maximum pressure level.

The task of the invention is solved according to a second aspect of the invention by means of a method for operating a pneumatic actuator, wherein the actuator comprises an actuator housing with an actuator bore and a movable working piston, in particular linearly movable or pivotable, along a path of movement in the actuator bore, wherein the working piston divides the actuator bore into a size-variable first working chamber and a size-variable second working chamber, comprising the steps of: determining a first working pressure in the first working chamber, determining a second working pressure in the second working chamber, determining an actual position of the working piston along the path of movement, receiving a movement task and determining at least one parameter from the group: actuator target stiffness, actuator fault stiffness, actuator minimum speed, actuator maximum speed, actuator positioning accuracy, from the movement task to be performed by the working piston, determining a first maximum pressure level for the first working chamber as a function of the at least one parameter, determining a second maximum pressure level for the second working chamber that depends on the at least one parameter, performing a first pressure control for the first working chamber with the first maximum pressure level, performing a second pressure control for the second working chamber with the first maximum pressure level in order to perform the movement task for the working piston.

In an advantageous further development of the method, it is provided that that during the execution of the movement task for the working piston, an actual position of the working piston is determined on the basis of a progression or curve of the first working pressure and on the basis of a progression or curve of the second working pressure, and that a position control is carried out with the actual position and a target position for the working piston calculated from the movement task, taking into account the first maximum pressure level and the second maximum pressure level.

In a further embodiment of the method, it is provided that that during the execution of the movement task for the working piston, an actual position of the working piston is determined on the basis of a position signal from a position sensor associated with the actuator, and that a position control (closed loop) is carried out using the actual position and a target position for the working piston calculated from the movement task, taking into account the first maximum pressure level and the second maximum pressure level.

In an advantageous further development of the method, it is provided that the movement task includes a change in at least one parameter as a function of a position change of the working piston and that an adjustment of the first maximum pressure level and the second maximum pressure level is carried out as a function of the position change of the working piston.

In a further embodiment of the method, it is provided that the first maximum pressure level and the second maximum pressure level result from a mean pressure optimization which is carried out by the controller on the basis of at least one boundary condition from the group: actuator position deviation, actuator target speed, actuator target stiffness, actuator minimum speed, actuator maximum speed.

### BRIEF DESCRIPTION OF THE DRAWINGS

An advantageous embodiment of the invention is shown in the drawing. Here shows:

FIG. 1 a first embodiment of a valve system in which the first valve group and the second valve group are each designed as electrofluidic 3/2-way valves and are assigned a pneumatic cylinder as an actuator and a position sensor, and

FIG. 2 a second embodiment of a valve system in which the first valve group and the second valve group are each designed as a half-bridge consisting of two 2/2-way valves and are assigned an actuator designed as a rotary actuator.

### DETAILED DESCRIPTION

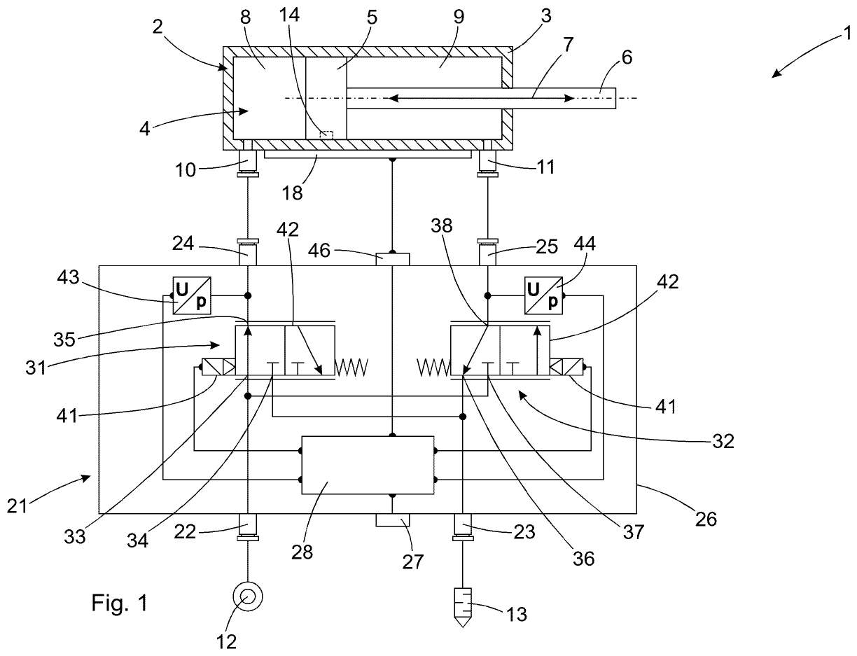

A pneumatic system 1 shown in FIG. 1 comprises an actuator 2, a fluid source 12, and a valve system 21. The actuator 2 is designed purely as an example as a pneumatic cylinder and comprises a cylinder housing 3, also referred to as an actuator housing, in which a cylinder bore 4, also referred to as an actuator bore, is formed. Actuators such as rotary actuators, pneumatic muscles, or other systems that can convert compressed air flows into movements can also be used in place of the pneumatic cylinder. A working piston 5 is mounted in the cylinder bore 4 so as to be linearly movable, and a piston rod 6 is attached to the working piston 5. The piston rod 6 passes through the cylinder housing 3 at the front end and can be coupled in a manner not shown to a machine component which is to be set in motion by the actuator 2. In order to cause linear movement of the working piston 5 and the piston rod 6 along a movement path designated as the movement axis 7, a first working chamber 8 and a second working chamber 9 can be selectively aerated or de-aerated via an associated first fluid connection 10 and a second fluid connection 11. Aeration causes an increase in pressure in the respective working chamber 8, 9, while de-aeration causes a decrease in pressure in the respective working chamber 8, 9. Depending on a first fluid pressure in the first working chamber 8 and on a second working pressure in the second working chamber 9, pressure forces are generated which act, among other things, on the working piston 5. If there is a balance of forces between the pressure forces acting on the working piston 5 in the first working chamber 8 and the pressure forces acting on the working piston 5 in the second working chamber 9, there is no movement of the working piston 5 and the piston rod 6 (provided that no external forces act on the piston rod 6). If, on the other hand, there is a difference between the pressure forces acting on the working piston 5 in the respective working chambers 8, 9, this can cause the working piston 5 and the piston rod 6 to move.

The valve system 21 is provided to change the first fluid pressure in the first working chamber 8 and to change the second fluid pressure in the second working chamber 9. The valve system 21 comprises, purely by way of example, a first valve group 31, a second valve group 32, a first pressure sensor 43, a second pressure sensor 44, and a controller 28, wherein these components are arranged in a common valve housing 26.

By way of example, the first valve group 31 and the second valve group 32 are each designed as proportionally controllable electrofluidic 3/2-way valves. Such a 3/2-way valve is controlled by an electrical signal provided by the controller 28, wherein a solenoid pilot valve 41, which is shown only schematically, receives this electrical signal and converts it into a valve movement of a valve member not shown in detail. This valve movement of the valve member of the solenoid pilot valve 41 supplies control air to a valve member of a main valve 42 so that this valve member can be transferred from a first operating state to a second operating state. By way of example for the following description, it is envisaged that the first valve group 31 is in the second operating state while the second valve group 32 is in the first operating state. By way of example, the 3/2-way valves of the two valve groups 31 and 32 are designed such that they assume the first operating state without an electrical signal. In contrast, the 3/2-way valves of the two valve groups 31 and 32 are transferred from the first operating state to the second operating state when an electrical signal is present, whereby the position of the respective valve elements can be adjusted proportionally to a signal level of the electrical signal.

By way of example, it is provided that a first input connection 33 of the first valve group 31 and a second input connection 37 of the second valve group 32 are connected to a supply connection 22, which in turn is connected to a fluid source 12. Furthermore, a second input connection 34 of the first valve group 31 and a first input connection 35 of the second valve group 32 are connected to an exhaust connection 23, on which a silencer 13 is arranged purely by way of example. An outlet connection 35 of the first valve group 31 is connected to a first working connection 24, which in turn is connected to the first fluid connection 10. An outlet connection 38 of the second valve group 32 is connected to a second working connection 25, which in turn is connected to the second fluid connection 11.

Accordingly, the first valve group 31 can, in the first operating state not shown, open an exhaust path between the first working connection 24 and the exhaust connection 23 and, in the second operating state, as shown in FIG. 1 for the first valve group 31, open a supply path between the supply connection 22 and the first working connection 24.

Furthermore, the second valve group 32 can, in the first operating state, as shown in FIG. 1 for the second valve group 31, open an exhaust path between the second working connection 25 and the exhaust connection 23 and, in the second operating state not shown, open a supply path between the supply connection 22 and the second working connection 25.

The controller 28 associated with the valve system 21 is electrically connected with the first valve group 31 and the second valve group 32. Furthermore, the controller 28 is electrically connected to a first pressure sensor 43, which is assigned to the first working connection 24, and electrically connected to a second pressure sensor 44, which is assigned to the second working connection 25. In addition, the controller 28 is electrically connected to a sensor interface 46 to which a position sensor 18 is connected, which is assigned to the actuator 2. By way of example, the position sensor 18 is designed to determine a position of a permanent magnet 14 arranged in the working piston 5 and to provide a sensor signal dependent on the position of the permanent magnet 14 to the controller 28. The controller 28 is also connected to a communication interface 27 via which communication with a higher-level machine control system, in particular a programmable logic controller (PLC), which is not shown, can be carried out, in particular using a bus protocol.

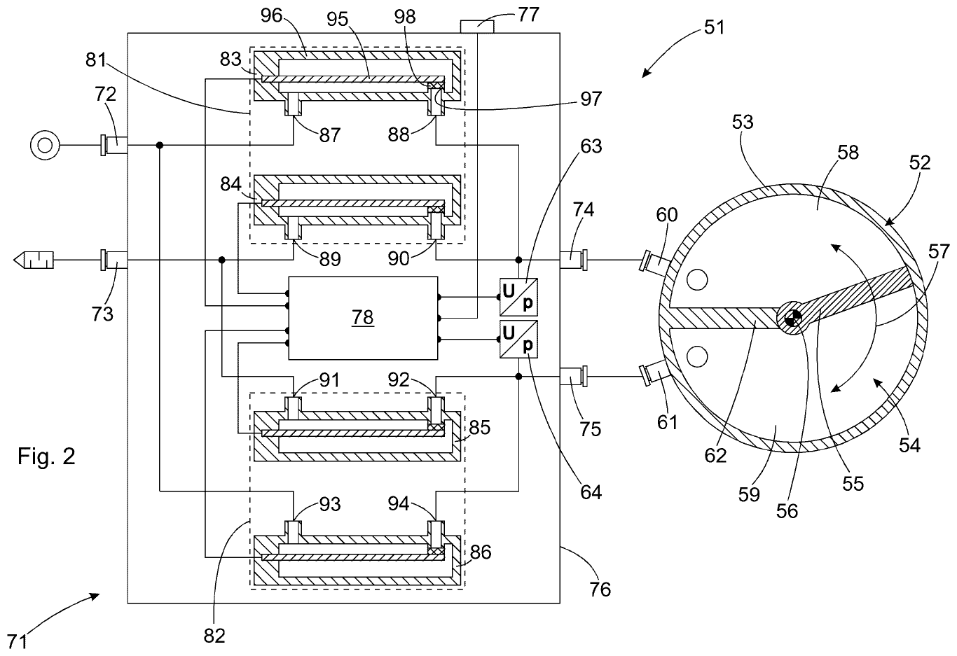

In the second embodiment of a valve system 71, as shown in FIG. 2, piezo valves 83 and 84 form a first valve group 81, while the piezo valves 85 and 86 form a second valve group 82. Both valve groups 81, 82 are located in a valve housing 76. The valve housing 76 is provided on an outer surface with a supply connection 72, an exhaust connection 73, a first working connection 74, a second working connection 75 and a communication interface 77, which are connected with the valve groups 81, 82. . . . Each of the piezo valves 83 to 86 is designed as a 2/2-way valve and each has a piezo bender 95 fixed at one end in a valve cartridge 96, which piezo bender 95 is provided at a free end with a sealing element 98 that is intended for sealing contact with a valve seat 97 formed in the valve cartridge 96. Starting from a first functional position shown in FIG. 2, the piezo bender 95 can be moved into a curved state not shown by applying an electrical voltage that can be supplied by a controller 78, in which the sealing element 98 is lifted off the valve seat 97 so that a fluid flow through the valve seat 97 is enabled.

By way of example, it is provided that a first input connection 87 of the piezo valve 83 and a fourth input connection 93 of the piezo valve 86 are connected to the supply connection 72, which is connected to the fluid source 12. Furthermore, it is provided, for example, that a second input connection 89 of the piezo valve 84 and a third input connection 91 of the piezo valve 85 are connected to the exhaust port 73, to which the silencer 13 is attached. A first output connection 88 of the piezo valve 83 and a second output connection 90 of the piezo valve 84 are connected to the first working connection 74. A third outlet connection 92 of the piezo valve 85 and a fourth outlet connection 94 of the piezo valve 86 are connected to the second working connection 75.

A first pressure sensor 43 is assigned to the first working connection 74 and is electrically connected to the controller 78. A second pressure sensor 44 is assigned to the second working connection 75 and is electrically connected to the controller 78.

As an example, the pneumatic system 51 according to FIG. 2 has an actuator 52 designed as a rotary actuator. Actuators such as pneumatic cylinders, pneumatic muscles, or other systems that can convert compressed air flows into movements can also be used in place of the rotary actuator. The actuator 52 has an actuator housing 53, which is shown only schematically and is of circular cylindrical design, with a circular cylindrical actuator bore 54. A swivel wing 55 is mounted in the actuator bore 54 so that it can pivot along a circular section-shaped movement path 57 about a pivot axis 56 aligned perpendicular to the plane of FIG. 2. The swivel wing 55 is sealed against a housing web 62 arranged fixedly in the actuator bore 54 and the inner surfaces of the actuator bore 54. The swivel blade 55 thus separates a first working chamber 58 from a second working chamber 59 together with the housing web 62 and the inner surfaces of the actuator bore 54. A first fluid connection 60 opens into the first working chamber 58 and is connected to the first working connection 74. A second fluid connection 61 opens into the second working chamber 59 and is connected to the second working connection 75.

The controller 78 is electrically connected to the piezo benders 95 of the piezo valves 83 to 86 and can influence an individual bending state and thus also an individual opening or closing state for the respective piezo valve 83 to 86 by supplying electrical control voltages to the respective piezo benders 95. It is preferably provided that the piezo valves 83 to 86 are controlled in pairs in opposite directions. For example, it may be provided that the first piezo valve 83 and the fourth piezo valve 86 are opened simultaneously in order to ventilate/aerate the first working chamber 58 and to vent/de-aerate the second working chamber 59, thereby causing the swivel wing 55 to pivot clockwise (as shown in FIG. 2). For a counterclockwise swivel movement of the swivel blade 55, however, the second piezo valve 84 and the third piezo valve 85 must be provided to open.

In both the pneumatic system 1 according to FIG. 1 and the pneumatic system 51 according to FIG. 2, the respective controller 28, 78 can receive a movement task from a higher-level control system (not shown) via the associated communication interface 27, 77. From this movement task, which may be a numerical computer command string, the controller 28, 78 can derive a first maximum pressure level and a second maximum pressure level or, if necessary, determine these by referring to data stored in the controller 28, 78. When executing the movement task, the controller 28, 78 is designed to limit the first pressure regulator to the first maximum pressure level and to limit the second pressure regulator to the second maximum pressure level, respectively, in order to be able to perform the movement task with the minimum amount of compressed air required to comply with the boundary conditions contained in the movement task, such as actuator position deviation and/or actuator target speed and/or actuator target stiffness and/or actuator minimum speed and/or actuator maximum speed.

This limitation of the first and second maximum pressure levels can be carried out on the basis of stored maximum pressure levels, provided that the actuator is always to perform the same movement task. For this purpose, the maximum pressure levels for performing the motion task can be determined experimentally, whereby the experimental determination is aimed at achieving the movement of the actuator taking into account all boundary conditions such as positioning speed, positioning accuracy, actuator stiffness, and with minimum energy consumption.

For changing motion tasks, it can be provided that the first and second maximum pressure levels are determined from a motion task which may, for example, be aimed at moving the working piston of the actuator at a predetermined travel speed and/or while maintaining a predetermined stiffness and/or with a predetermined positioning accuracy. The motion task can also be designed so that the travel speed and/or the stiffness and/or the positioning accuracy are varied during the movement of the working piston.

In order to be able to determine the first maximum pressure level and the second maximum pressure level from the motion task, the controller can be designed to perform a mean pressure optimization. This mean pressure optimization aims to determine the mean pressure required to fulfill the movement task, in particular a mean value from the first working pressure in the first working chamber and the second working pressure in the second working chamber, for example using a calculation model stored in the controller, and to calculate the first maximum pressure level and the second maximum pressure level based on this calculation model. The mean pressure optimization aims to find the minimum mean pressure at which the movement task can still be performed. For this purpose, the controller takes into account not only the boundary conditions contained in the movement task, but also the dimensions of the actuator and/or the properties of a component to be moved by the actuator. The component to be moved may, for example, be a machine part that is to be moved by the actuator between a first functional position and a second functional position. During the subsequent execution of the motion task, the compressed air is then supplied to the first and second working chambers of the actuator while maintaining the first maximum pressure level and the second maximum pressure level.

It is understood that the valve system 21 can be used not only to control the actuator 2 but also to control the actuator 52 or an actuator not shown which has two working chambers. This also applies analogously to the valve system 71.

1. A valve system for supplying a pneumatic actuator, with a supply connection, an exhaust connection, a first working connection to which a first pressure sensor is assigned, and a second working connection to which a second pressure sensor is assigned, and with a first valve group which is connected to the supply connection and to the exhaust connection and to the first working connection and which, in a first operating state, opens an exhaust path between the first working connection and the exhaust connection and, in a second operating state, opens a supply path between the supply connection and the first working connection, and with a second valve group which is connected to the supply connection and to the exhaust connection and to the second working connection and which, in a first operating state, opens an exhaust path between the second working connection and the exhaust connection and, in a second operating state, opens a supply path between the supply connection and the second working connection and with a controller for processing a first pressure signal from the first pressure sensor and a second pressure signal from the second pressure sensor, the controller comprising a first pressure regulator for controlling the first valve group and a second pressure regulator for controlling the second valve group, the controller setting a first maximum pressure level for the first pressure regulator and setting a second maximum pressure level for the second pressure regulator.

2. The valve system according to claim 1, wherein the controller has a sensor interface for connection to a position sensor and to process position signals from the position sensor, and wherein the controller has a position regulator an actuator position control based on the position signal.

3. The valve system according to claim 1, wherein the controller processes the first pressure signal of the first pressure sensor and the second pressure signal of the second pressure sensor to determine position information for an actuator and to use the position information with a position regulator for an actuator position control.

4. The valve system according to claim 1, wherein the controller has a communication interface for receiving a movement task from a higher-level machine control and to process the movement task in order to extract from the movement task at least one parameter from the group: first maximum pressure level, second maximum pressure level, actuator position deviation, actuator target speed, actuator target stiffness, actuator minimum speed, actuator maximum speed, and to determine the first maximum pressure level and the second maximum pressure level on the basis of the at least one parameter.

5. The valve system according to claim 1, wherein the first valve group and the second valve group comprise piezo valves or solenoid valves or fluidically pilot-controlled valves.

6. The valve system according to claims 1, wherein the first valve group and the second valve group comprise 3/2-way valves or 3/3-way valves or two 2/2-way valves which are arranged in a full-bridge circuit.

7. The valve system according to claim 1, wherein the controller is designed such that the first maximum pressure level and the second maximum pressure level result from a mean pressure optimization which is carried out by the controller on the basis of at least one boundary condition from the group: actuator position deviation, actuator target speed, actuator target stiffness, actuator minimum speed, actuator maximum speed.

8. A method for operating a pneumatic actuator, wherein the actuator has an actuator housing with an actuator bore and a working piston which is movable along a movement path in the actuator bore, wherein the working piston divides the actuator bore into a size-variable first working chamber and a size-variable second working chamber, comprising the steps of: determining a first working pressure in the first working chamber, determining a second working pressure in the second working chamber, determining an actual position of the working piston along the movement path, receiving a movement task and determining at least one parameter from the group: actuator target stiffness, actuator disturbance stiffness, actuator minimum speed, actuator maximum speed, actuator positioning accuracy, from the movement task to be performed by the working piston, determining a first maximum pressure level for the first working chamber dependent on the at least one parameter, determining a second maximum pressure level for the second working chamber that depends on the at least one parameter, performing a first pressure control for the first working chamber with the first maximum pressure level, performing a second pressure control for the second working chamber with the first maximum pressure level in order to perform the movement task for the working piston.

9. The method according to claim 8, wherein during the execution of the movement task for the working piston, an actual position of the working piston is determined on the basis of a progression of the first working pressure and on the basis of a progression of the second working pressure, and wherein a position control is executed with the actual position and a target position for the working piston calculated from the movement task, taking into account the first maximum pressure level and the second maximum pressure level.

10. The method according to claim 8, wherein during the execution of the movement task for the working piston, an actual position of the working piston is determined during the execution of the movement task for the working piston on the basis of a position signal from a position sensor associated with the actuator, and that a position control is carried out with the actual position and a target position for the working piston calculated from the movement task, taking into account the first maximum pressure level and the second maximum pressure level.

11. The method according to claim 8, wherein the movement task includes a change in the at least one parameter as a function of a position change of the working piston and wherein an adjustment of the first maximum pressure level and the second maximum pressure level is performed as a function of the position change of the working piston.

12. The method according to claim 8, wherein the first maximum pressure level and the second maximum pressure level result from a mean pressure optimization which is performed by the controller based on at least one boundary condition from the group: actuator position deviation, actuator target speed, actuator target stiffness, actuator minimum speed, actuator maximum speed.
